(19) United States
(12) Patent Application Publication
(10) Pub. No.: US 2021/0115714 A1
(43) Pub. Date: Apr. 22, 2021

(54) FURNITURE FITTING

(71) Applicant: Julius Blum GmbH, Hoechst (AT)

(72) Inventor: Stefan DUER, Schwarzach (AT)

(21) Appl. No.: 17/136,756

(22) Filed: Dec. 29, 2020

Related U.S. Application Data
(63) Continuation of application No. PCT/AT2019/060211, filed on Jun. 27, 2019.

(30) Foreign Application Priority Data
Jul. 3, 2018 (AT) A 50577/2018

(51) Int. Cl. E05D 5/02; E05D 7/00

(52) U.S. Cl. CPC E05D 5/0276; E05Y 2900/20; E05D 7/0009

(57) ABSTRACT

A furniture fitting includes a first fitting portion to be fixed to a furniture carcass, and a second fitting portion to be fixed to a movable furniture part, the two fitting portions being pivotally connected by a hinge axis member. The first fitting portion can be inserted into a recess in the furniture carcass, and/or the second fitting portion can be inserted into a recess in the movable furniture part. The first fitting portion and/or the second fitting portion includes a longitudinal housing having two end sections spaced apart. The hinge axis member is arranged on a first end section of the housing, and the first fitting portion and/or the second fitting portion includes a fastening device having a movably-mounted actuating element formed as a rotatable screw. By actuating the actuating element, at least one fitting portion can be fixed within the recess on both end sections of the housing.

### BACKGROUND OF THE INVENTION

The present invention relates to a furniture fitting for movably supporting a movably-mounted furniture part relative to a furniture carcass. The furniture fitting includes a first fitting portion configured to be fixed to the furniture carcass, and a second fitting portion configured to be fixed to the movable furniture part, with the two fitting portions being pivotally connected to one another by at least one hinge axis member. The first fitting portion is configured to be at least partially inserted into a recess in the furniture carcass, and/or the second fitting portion is configured to be at least partially inserted into a recess in the movable furniture part. The first fitting portion and/or the second fitting portion includes a longitudinal housing having two end sections spaced from each other in the longitudinal direction, and the at least one hinge axis member is arranged on a first end section of the housing.

Moreover, the invention concerns an item of furniture comprising a furniture carcass and a movable furniture part which is movably supported relative to the furniture carcass by at least one fitting portion of the type to be described.

WO 2016/174071 A1 shows in FIG. 9 a furniture hinge for pivotally supporting a door. The second fitting portion is received within a recess of the door and is configured substantially L-shaped. The L-form of the second fitting portion is necessary, because in a region of the hinge axes of the two hinged levers connecting the first fitting portion to the second fitting portion to one another, there is no space available for the arrangement of a fastening screw. However, the L-shaped second fitting portion is a special type which, in serial production, requires an additional expenditure on materials and causes extra costs. Moreover, the L-shaped second fitting portion forms a relatively voluminous construction which does not sufficiently fulfil the need for a compact construction of the furniture fitting.

DE 1 966 537 A1 discloses a spreading and holding device for hinge portions for movably supporting a door. A recess is arranged in the door, and the recess has circled surfaces of an identical diameter overlapping one another, and the hinge portion is configured to be countersunk within the recess. The hinge portion includes a longitudinal housing having half-cylindrical end faces, and a rotatable eccentric having a slit for positioning a screwdriver is arranged on a first end section of the housing. A hinge axis member is arranged on a second end section of the housing. By rotating the eccentric with the aid of the screwdriver, an elastically yielding wall can be pressed against an inner side of the recess. A drawback is the fact the adjustment path of an eccentric is relatively limited. For a reliable fixing with the aid of the eccentric, the size of the recess must be exactly tailored to the size of the housing. If the size of the recess exceeds a predetermined dimension, a rotational movement of the eccentric, due to its eccentric curve configuration, leads to an abrupt decrease of the pressing force, whereby the housing can no longer be fixed within the recess.

DE 297 17 508 U1 discloses a furniture hinge having a hinge cup configured to be fixed within a bore of a furniture part by virtue of a handle pivotally mounted on the hinge cup. By a tilting movement of the handle, a bracket body can be pressed against an inner side of the bore. A drawback is the fact that the structural design of the furniture hinge is relatively complex.

### SUMMARY OF THE INVENTION

It is an object of the present invention to propose a furniture fitting of the type mentioned in the introductory part, thereby avoiding the drawbacks as discussed above.

According to the invention, the first fitting portion and/or the second fitting portion includes or include a fastening device having at least one movably-mounted actuating element in the form of a rotatable screw. By an actuation of the at least one actuating element, the first fitting portion and/or the second fitting portion is or are configured to be fixed within the recess on both end sections of the housing.

Accordingly, the first fitting portion and/or second fitting portion includes or include a longitudinal housing having two end sections spaced from one another in the longitudinal direction. Each of the end sections, by an actuation of the actuating element, is configured to be pressed against a contact surface of the recess in the furniture carcass and/or in the movable furniture part either directly or via at least one locking element.

The actuating element of the fastening device can be arranged on a region separate from the first end section, on which the hinge axis member is arranged, of the housing. According to a possible embodiment, the actuating element of the fastening device is arranged on the second end section of the housing.

The first and/or the second fitting portion of the furniture fitting can have precisely one fastening device for fixing to the movable furniture part. In other words, one single fastening device of the fitting portions can be generally sufficient for reliably fixing to the furniture carcass and/or to the movable furniture part. However, if appropriate, additional securing means (for example a fastening screw) may be provided.

By an actuation of the actuating element, at least one locking element is movable, so that the housing can be fixed within the recess of the furniture carcass and/or within the recess of the movable furniture part by the at least one locking element.

Preferably, the actuating element, in all operating positions, is captively secured to the first and/or second fitting portion.

The actuating element can be connected to the locking element in a movement-coupled manner, for example by a transmission mechanism having co-operating tooth arrangements. With a constructively simple solution, the actuating element can be in threading engagement with the locking element.

With an embodiment of the invention, the at least one locking element includes a first inclined surface portion configured to co-operate with a corresponding second inclined surface portion. The at least one locking element is movable, due to the co-operation of the first and second inclined surface portions, in a first direction extending transversely to a rotational axis of the actuating element by rotating the actuating element in a first rotational direction. In this way, it is possible that the housing of the fitting portion(s) can be connected, by the locking element, in a force-locking manner with the contact surfaces of the recess which are provided for this purpose.

Thereby, the at least one locking element, by rotating the actuating element in a second rotational direction opposite the first rotational direction, can be movable by the co-operation of the first inclined surface portion and the second inclined surface portion, in a second direction opposite the first direction. In this way, it is possible to actively move back the locking element from a locking position within the recess into a position in which the housing of the second fitting portion can be removed from the recess, without damaging the associated contact surfaces and without any substantial frictional resistance.

The at least one locking element, at least over a region, can have a surface for increasing the static friction, for example nubs, ribs or a tooth arrangement, configured to bear against the recess.

According to an embodiment of the invention, the first fitting portion can include a mounting portion having at least one fixing device for mounting the mounting portion to a furniture panel. The first fitting portion includes at least one coupling portion hingedly connected to the second fitting portion, and the coupling portion is configured to be releasably connected to the mounting portion. In other words, the carcass-sided first fitting portion of the furniture fitting has at least a two-part configuration and includes a mounting portion which, in a first mounting step, is to be fixed to or within a horizontally or vertically extending furniture panel of the furniture carcass by the at least one fixing device. Further, a coupling portion is provided, the coupling portion being hingedly connected to the second fitting portion and being configured to be fixed—independently and separately from the mounting portion—to the movable furniture part in a second mounting step. After the mounting portion and the coupling portion have been pre-mounted, the mounting portion and the coupling portion are configured to be releasably connected to one another (preferably automatically locked to one another) in a third mounting step, whereby the mounting of the movable furniture part on the furniture carcass can be considerably facilitated.

The furniture panel of the furniture carcass usually has a predetermined material thickness (for example 16 mm or 19 mm). According to a preferred embodiment, the mounting portion of the first fitting portion is configured to be received within the predetermined material thickness of the furniture panel. The mounting portion can have a height extension and a longitudinal extension, and the length extension is at least three times, preferably at least six times, as large than the height extension of the mounting portion.

The furniture fitting, for example, can be configured as a furniture hinge. However, it is also possible that the furniture hinge is configured as a furniture drive for moving a furniture flap, the flap being pivotally mounted about a horizontally extending axis in a mounted condition on a furniture carcass.

According to an embodiment, the housing of the first and/or second fitting portion is configured substantially cuboid-shaped.

### BRIEF DESCRIPTION OF THE DRAWINGS

Further details and advantages of the present invention will be explained with the aid of the embodiment shown in the figures.

FIG. 1a, 1b show an item of furniture and a furniture fitting (without the mounting portion) in perspective views,

FIG. 2a-2c show the mounting procedure of the movable furniture part on the furniture carcass in schematic top views,

FIG. 3a-3c show a temporal sequence of the mounting procedure of the coupling portion to the mounting portion in different cross-sectional views,

FIG. 4a, 4b show further temporal sequences of the mounting procedure of the coupling portion to the mounting portion in different cross-sectional views,

FIG. 5a-5c are different views of the second fitting portion to be fixed to the movable furniture part, in which the locking element is in a release position,

FIG. 6a-6c are different views of the second fitting portion fixed to the movable furniture part, in which the locking element is in a clamping position,

FIG. 7a-7c are a perspective view of a furniture fitting, in which the first fitting portion includes a fastening device for fastening to a furniture carcass, and two cross-sectional views with the fastening device in a release position and in a clamping position within the recess of the furniture carcass,

FIG. 8a-8d show a further embodiment of a fastening device for fastening the fitting portions to the furniture carcass and/or to the movable furniture part.

### DETAILED DESCRIPTION OF THE INVENTION

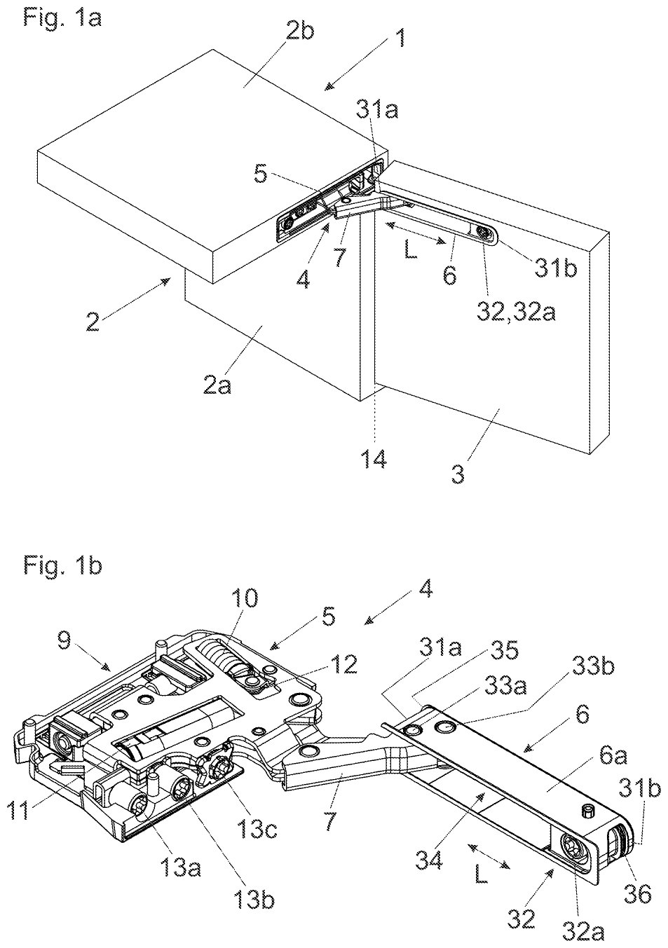

FIG. 1a shows a perspective view of an item of furniture 1 with a furniture carcass 2 which is only partially depicted. A movable furniture part 3, preferably in the form of a door or a furniture flap, is pivotally supported in the mounted position about an, preferably vertically extending, axis 14 relative to the furniture carcass 2 by a furniture fitting 4. The furniture carcass 2 includes a vertically extending sidewall 2a and a horizontally extending furniture panel 2b (preferably a top panel, a bottom panel or a shelf arranged between the top panel and the bottom panel), and the first fitting portion 5 of the furniture fitting 4 is supported on or within the furniture panel 2b. Of course, it is also possible for the furniture fitting 4 to be fixed to the vertically extending sidewall 2a, so that the movable furniture part 3, in the mounted condition, is pivotally supported relative to the furniture carcass 2 about a horizontally extending axis 14.

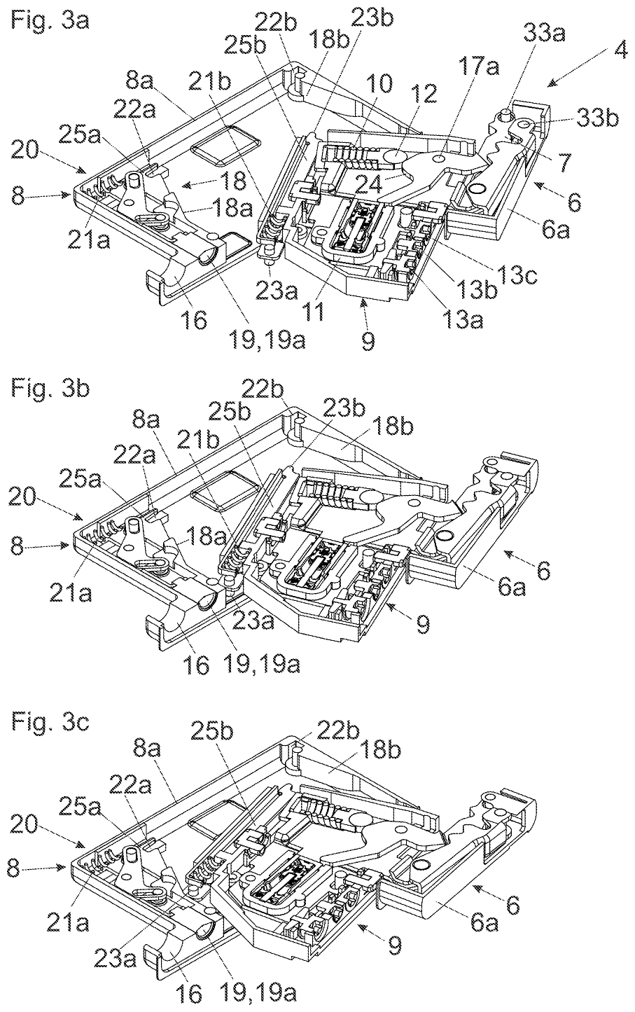

FIG. 1b shows the furniture fitting 4 (without the mounting portion 8) in a perspective view. The first fitting portion 5 has at least a two-part configuration and includes a mounting portion 8 (FIG. 3a) configured to be pre-mounted to or within the furniture panel 2b. The mounting portion 8 has a, preferably pocket-shaped, housing 8a for at least partially receiving the coupling portion 9. The mounting portion 8 and the coupling portion 9 are configured to be releasably connected to one another. In a first mounting step, the mounting portion 8 is to be fixed to or within the furniture panel 2b. The coupling portion 9 is pivotally connected to the second fitting portion 6 by at least one hinged lever 7. The second fitting portion 6, in a second mounting step, is to be fixed to the movable furniture part 3 via a longitudinal housing 6a. After the mounting portion 8 has been fixed to the furniture panel 2b and the second fitting portion 6 has been fixed to the movable furniture part 3, the mounting portion 8 and the coupling portion 9 can be connected to one another by joining them together. For example, the mounting portion 8 and the coupling portion 9 can be fixed to one another by at least one screw connection. It is preferably provided that the mounting portion 8 and the coupling portion 9 are configured to be automatically locked to one another by at least one locking device 20 (FIG. 3a).

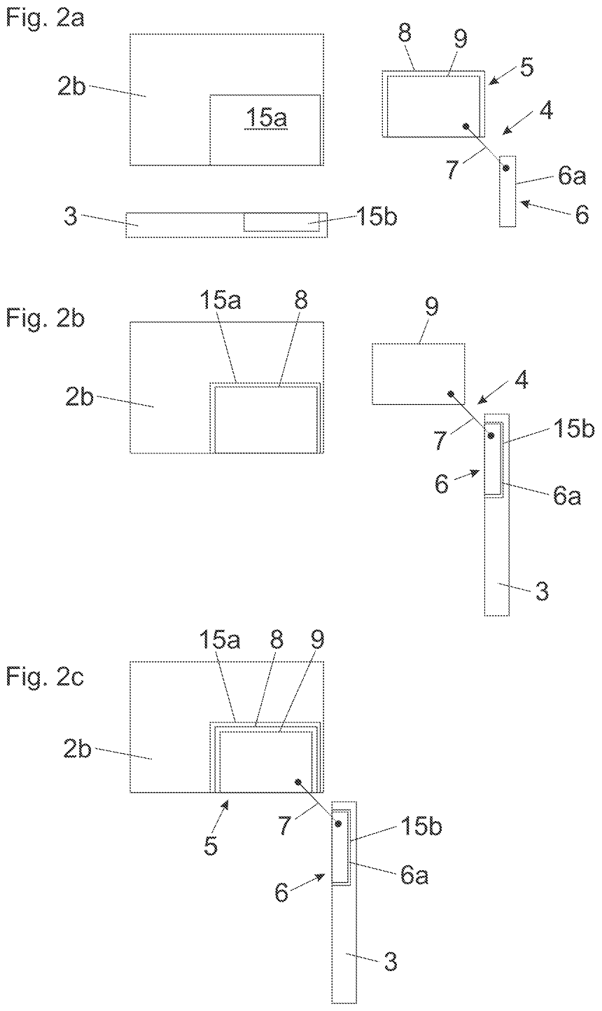

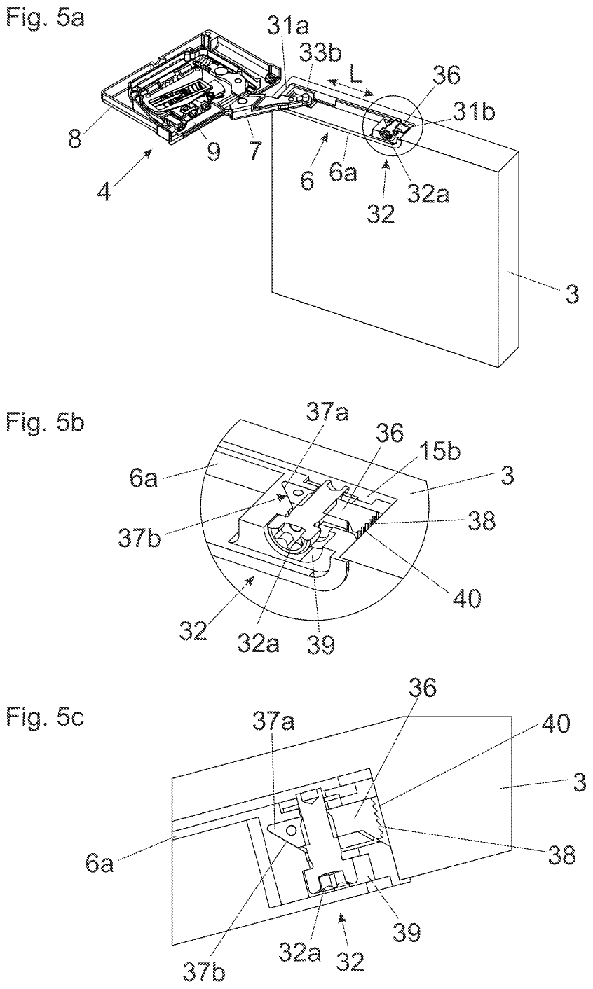

The second fitting portion 6 is pivotally connected to the first fitting portion 5 by at least one hinge axis member 33a, 33b (FIG. 1b). The second fitting portion 6 is configured to be at least partially inserted into a recess 15b in the movable furniture part 3. The second fitting portion 6 includes a longitudinal housing 6a with two end sections 31a, 31b spaced from one another in the longitudinal direction (L), and the housing 6a includes a cavity 34 for receiving the hinged lever 7 in at least one relative position of the furniture fitting 4. The at least one hinge axis member 33a, 33b is arranged on the first end section 31a, whereas a fastening device 32 with a rotatably mounted actuating element 32a in the form of a rotatable screw is provided on a region of the housing 6a which is separate from the first end section 31a. By an actuation of the actuating element 32a, the second fitting portion 6 can be fixed on both end sections 31a, 31b of the housing 5a within a recess 15b (FIG. 2a) of the movable furniture part 3. Thereby, it can be provided that by an actuation of the actuating element 32a, at least one locking element 36 can be pressed against a contact surface 40 (FIG. 5c) of the recess 15b.

On the first end section 31a of the housing 6a, on which the at least one hinge axis 33a, 33b is arranged, at least one protrusion 35 is arranged. The protrusion 35 can be pressed against a corresponding contact surface 40 of the recess 15b by an actuation of the actuating element 32a, whereby the grip of the first end section 31a of the housing 6a on the movable furniture part 3 can be additionally improved. If appropriate, the at least one protrusion 35 is configured to penetrate into the wood material of the movable furniture part 3 by an actuation of the actuating element 32a. Also, two or more protrusions 35 in the form of ribs, tooth arrangements or tips may be provided.

By at least one adjustment device 13a, 13b, 13c, in a connected condition between the mounting portion 8 and the coupling portion 9, a position of the coupling portion 9 relative to the mounting portion 8 can be adjusted, preferably in a three-dimensional manner. By a force of the spring device 10, the second fitting portion 6 is movable into the fully closed and/or fully open position relative to the first fitting portion 5. For example, this can be provided by a pressure roller 12 pressurized by the spring device 10. The pressure roller 12 is configured to run along a setting contour 24 (FIG. 3a) upon a movement of the hinged lever 7. By a damping device 11, preferably with a hydraulic piston-cylinder-unit, a movement of the second fitting portion 6 relative to the first fitting portion 5 can be decelerated. In this way, a movement of the second fitting portion 6 into the fully closed and/or fully open end-position can be dampened.

FIG. 2a-2c show the mounting procedure of the movable furniture part 3 on the furniture panel 2b of the furniture carcass 2 in schematic top views. A first recess 15a is formed in the furniture panel 2b for receiving the first fitting portion 5 of the furniture fitting 4, whereas a second recess 15b is arranged in the movable furniture part 3 for receiving the second fitting portion 6 of the furniture fitting 4. The first fitting portion 5 has at least a two-part configuration and includes a mounting portion 8 configured to be arranged within the first recess 15a, and a coupling portion 9 configured to be connected to the mounting portion 8. The first fitting portion 5 and the second fitting portion 6 are pivotally connected to one another by at least one hinged lever 7.

In a first mounting step (FIG. 2b), the mounting portion 8 is to be fixed within the first recess 15a of the furniture panel 2b, whereas the second fitting portion 6 is to be fixed to the movable furniture part 3. It is preferably provided that the longitudinal housing 6a of the second fitting portion 6 is configured to be substantially entirely countersunk within the second recess 15b of the movable furniture part 3. In a third mounting step (FIG. 2c), the mounting portion 8 and the coupling portion 9 are connected to one another, so that the movable furniture part 3 can be fixed to the furniture carcass 2.

FIG. 3a-3c show the mounting procedure of the coupling portion 9 on the mounting portion 8 in different mounting steps. The coupling portion 9 is connected to the second fitting portion 6 by the at least one hinged lever 7. The hinged lever 7 is pivotally supported on the coupling portion 8 about a hinge axis 17a, and is pivotally supported on the second fitting portion 6 about the hinge axis 33a. The setting contour 24 is arranged on the hinged lever 7, and a pressure roller 12 pressurized by the spring device 10 is configured to run along the setting contour 24 upon a movement of the hinged lever 7 about the first hinge axis 17a. The hinged lever 7 is configured as a double-armed lever having a first lever end and a second lever end. The first lever end of the hinged lever 7 is hingedly connected to the second fitting portion 6 via the hinge axis 33a. The damping device 11 is configured to be acted upon by the second lever end of the hinged lever 7. The second lever end of the hinged lever 7, for performing a damping hub, can act on the damping device 11 either directly or via at least one further component (for example via an intermediate lever). In a first mounting step, the mounting portion 8 is to be fixed by at least one fixing device 16 (which may be configured, for example, as a hole for receiving a screw) to or within the furniture panel 2b

The mounting portion 8 can also include two or more fixing devices 16 configured as holes for receiving screws. It is also possible that the fixing device 16 includes a movably-mounted actuating element. The at least one locking element is configured to be moved by an actuation of the actuating element, and the mounting portion 8 can be fixed to or within the furniture panel 2b by the locking element in a force-locking manner.

In a further mounting step, the coupling portion 9 is inclinedly introduced into the pocket-shaped housing 8a of the mounting portion 8. Moreover, a centering device 18 for centering between the mounting portion 8 and the coupling portion 9 is provided. The centering device 18 includes at least one inclined surface portion 18a, 18b for guiding the coupling portion 9, the at least one inclined surface portion 18a, 18b being arranged on the mounting portion 8 and/or on the coupling portion 9.

For releasably locking between the coupling portion 9 and the mounting portion 8, at least one locking device 20 is advantageous. The locking device 20 includes at least one movably supported locking element 25a for releasably locking the coupling portion 9, the at least one locking element 25a being pressurized by a force storage member 21a (preferably configured as a compression spring). The locking element 25a is provided with a recess 22a for receiving a locking member 23a of the coupling portion 9. In the shown embodiment, a second force storage member 21b is provided, the second force storage member 21b being configured to push a second locking element 25b with a second locking member 23b in a direction of a second recess 22b of the mounting portion 8. As shown in FIG. 3b and FIG. 3c, the coupling portion 9 is laterally pivoted into the mounting portion 8, and the coupling portion 9 can be guided relative to the mounting portion 8 by the inclined surface portions 18a, 18b of the centering device 18.

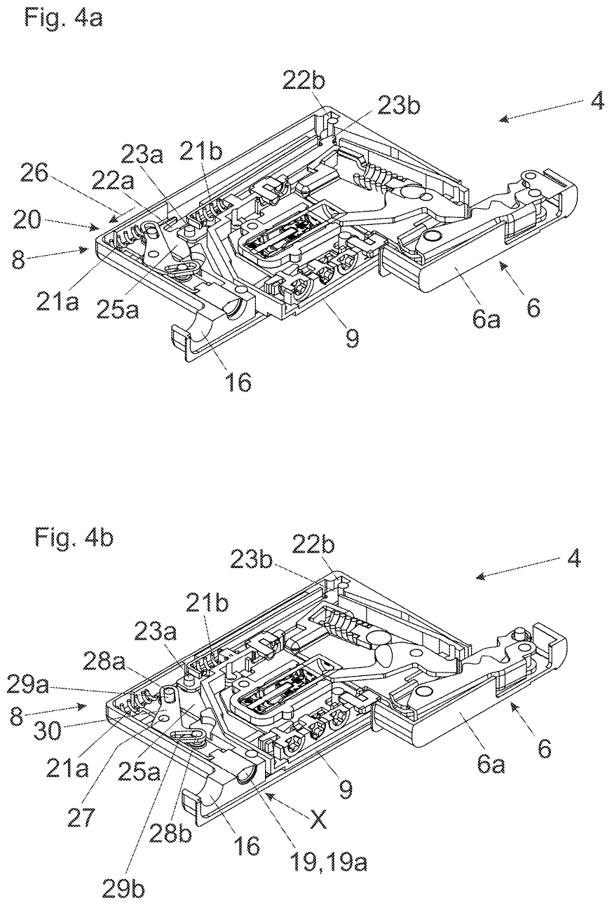

FIG. 4c shows, in relation to FIG. 3c, a continued pivoting movement of the coupling portion 9 relative to the coupling portion 8. The locking element 25a is pushed, against a force of the force storage member 21a, in a direction of the depicted arrow 26 due to the co-operation of the locking member 23a with an inclined surface portion of the locking element 25a. As result, the locking member 23a can enter into the recess 22a of the locking element 25a, and the second locking portion 23b can be pressed into the recess 22b of the mounting portion 8 by a force of the second force storage member 21b.

FIG. 4b shows the locked position between the mounting portion 8 and the coupling portion 9. By an unlocking device 19, the locking between the mounting portion 8 and the coupling portion 9 can be again released. The unlocking device 19 includes a movably-mounted, preferably linearly displaceable, release element 19a. By exerting a force to the release element 19a in the direction (X), the locking between the mounting portion 8 and the coupling portion 9 is configured to be released. The release element 19a, in the mounted condition of the furniture fitting 4, is immediately and directly accessible for an actuation with the aid of a tool.

In the shown embodiment, the unlocking device 19 includes a two-armed unlocking lever 30 pivotally supported about an axis 27. Elongated holes 29a, 29b are provided on both lever ends of the two-armed unlocking lever 30, the elongated holes 29a, 29b being provided for receiving pins 28a, 28b. The first pin 28a is arranged on the locking element 25a, whereas the second pin 28b is connected to the release element 19a. When the release element 19a is pushed in a direction (X) of the depicted arrow with the aid of a tool, preferably by a screwdriver, the locking element 25a is movable by the unlocking lever 30, against a force of the force storage member 21a, into a release position in which the locking between the mounting portion 8 and the coupling portion 9 can be released. It is preferably provided that the direction (X) extends substantially at a right angle to a front face of the first fitting portion 5.

FIG. 5a shows the furniture fitting 4, in which the second fitting portion 6 with the housing 6a is to be fixed to the movable furniture part 3. The at least one hinge axis 33b is arranged on the first end section 31a of the housing 6, whereas the fastening device 32 with the rotatable actuating element 32a is arranged on the second section 31b.

FIG. 5b shows the encircled region of FIG. 5a in an enlarged view. The actuating element 32a of the fastening device 32 is movement-coupled to at least one locking element 36. It is preferably provided that the actuating element 32a is in threading engagement with the locking element 36. The actuating element 32a is configured as a rotatable screw displaceably supported in a radial direction (for example with the aid of an elongated hole 39). The actuating element 32a can have a receiving device for a tool, so that the actuating element 32a can be rotated with the aid of the tool.

The locking element 36 has a first inclined surface portion 37a configured to co-operate with a corresponding second inclined surface portion 37, the second inclined surface portion 37 being preferably arranged on the housing 6a. By rotating the actuating element 32a in a first rotational direction, the locking element 36 is movable in a first direction extending transversely to the rotational axis of the actuating element 32a due to the co-operation of the first and second inclined surface portions 37a, 37b. Therefore, the locking element 36 can be moved in a direction of a contact surface 40 of the recess 15b arranged in the movable furniture part 3. The locking element 36 has, at least over a region, a surface 38 for increasing the static friction, preferably a least one rib and/or at least one tooth arrangement, for bearing against the recess 15b. FIG. 5c shows a cross-sectional view in which the locking element 36 is spaced from the contact surface 40 of the recess 15b by the formation of a gap and is, therefore, located in a release position.

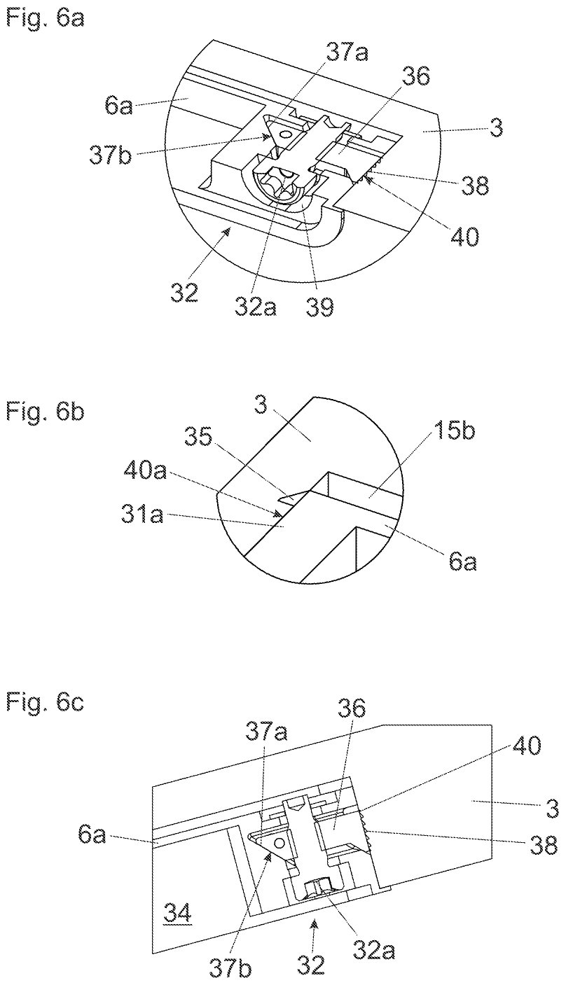

FIG. 6a shows the fixed condition of the second fitting portion 6 on the movable furniture part 3. Starting from the position according to FIGS. 5a-5c, the actuating element 32a has been rotated in the first rotational direction (in a clockwise direction) with the aid of a tool. By that rotational movement, the locking element 36 has been pulled closer to the head of the actuating element 32a. The locking element 36, due to the co-operation of the inclined surface portions 37a, 37b and due to the radial displaceability of the actuating element 32a, can be pressed against the contact surface 40 of the recess 15b arranged in the movable furniture part 3.

FIG. 6b shows the first end section 31a, on which the hinge axis 33b is arranged, of the housing 6a. By rotating the actuating element 32a, the longitudinal housing 6a has also been moved in a direction of an opposing second contact surface 40a of the recess 15b, and the protrusion 35 arranged on the second end section 31a of the housing 6a can be pressed against the second contact surface 40a of the recess 40 and/or can be penetrated into the second contact surface 40a. In this way, the housing 6a of the second fitting portion 6 can be clamped with both end sections 31a, 31b relative to both opposing contact surfaces 40, 40a of the recess 15b.

FIG. 6c shows a further cross-sectional view of the fastening device 32 arranged on the second end section 31b of the housing 6a, in which the locking element 36 is located in a fixed condition (clamping position) within the recess 15b in the movable furniture part 3.

The locking element 36 can be moved in a second direction, opposite the first direction, by rotating the actuating element 32a in a second rotational direction, opposite the first rotational direction, by the co-operation of the first and second inclined surface portions 37a, 37b. As a result, the distance between the surface 38 of the locking element 36 and the first contact surface 40 can be enlarged. In this way, the locking element 36 can be returned into the release position shown in FIG. 5c, so that the housing 6a of the second fitting portion 6 can be removed from the recess 15b, without damaging the contact surfaces 40, 40a.

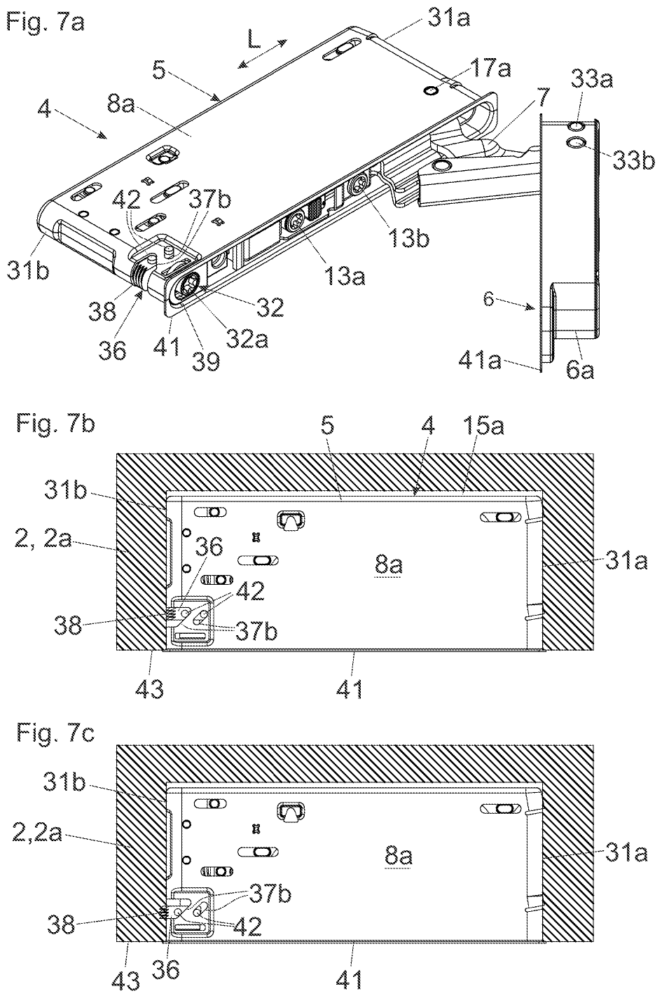

FIG. 7a shows a perspective view of the furniture fitting 4. The first fitting portion 5 includes at least one fastening device 32 for releasably fixing the housing 8a within the recess 15a of the furniture carcass 2. The housing 8a has two end sections 31a, 31b spaced from each other in the longitudinal direction (L), and the hinge axis member 17a of the hinged lever 7 is arranged in a region of the first end section 31a. The fastening device 32 having the rotatably mounted actuating element 32a in the form of a screw is arranged in a region of the second end section 31b. By at least one adjustment device 13a, 13b, a position of the housing 8a in relation to the furniture carcass 2, preferably in relation to the furniture panel 2a of the furniture carcass 2, can be adjusted. The fastening device 32 can be configured so as to be identical as the fastening device 32 shown in FIGS. 5a-5c, 6a-6c.

In the shown figure, the rotatable actuating element 32a is in threading engagement with the locking element 36, and the actuating element 32a is guided within the elongated hole 39 with radial play. At least one guide element 42, preferably in the form of a peg, is arranged on the locking element 36. The guide element 42, upon a rotation of the actuating element 32a, is displaceably guided along a, preferably inclinedly extending, guide 37b of the housing 8a. In this way, the locking element 36, with its surface 38 for increasing the static friction, can be pressed against an inner side of the recess 15a in the furniture carcass 2.

The housing 8a of the first fitting portion 5 and/or the housing 6a of the second fitting portion 6 can each have at least one laterally protruding flange 41, 41a. By a rear side of the flanges 41, 41a, a depth abutment member is formed, and the depth abutment member is configured to bear against a front face 43 of the furniture parts 2a, 3. Therefore, the fitting portions 5, 6, in a mounted condition, are held on a defined depth position in relation to the furniture panel 2a and/or in relation to the movable furniture part 3. Moreover, a gap formed between the fitting portions 5, 6 and the recesses 15a, 15b can be covered by the flanges 41, 41a. Further, a front face 43 arranged on an edge of the recesses 15a, 15b can be covered by the flanges 41, 41a in a mounted condition. In this way, an elaborate finishing of the edge, even if the edge is somewhat frayed, can be omitted.

FIG. 7b shows the housing 8a of the first fitting portion 5 in a release position of the fastening device 32, the housing 8a being countersunk in the furniture carcass 2, preferably within the furniture panel 2a. It is thereby visible that the surface 38 of the locking element 36 is not yet pressed against a corresponding inner side of the recess 15a.

FIG. 7c shows the housing 8a of the first fitting portion 5 in a clamping position of the fastening device 32, the housing 8a being countersunk in the furniture carcass 2, preferably within the furniture panel 2a. By rotating the actuating element 32a, the two guide elements 42 of the locking element 36 have been moved along the guides 37b, and the surface 38 of the locking element 36 can be pressed onto or pressed into the inner side of the recess 15a.

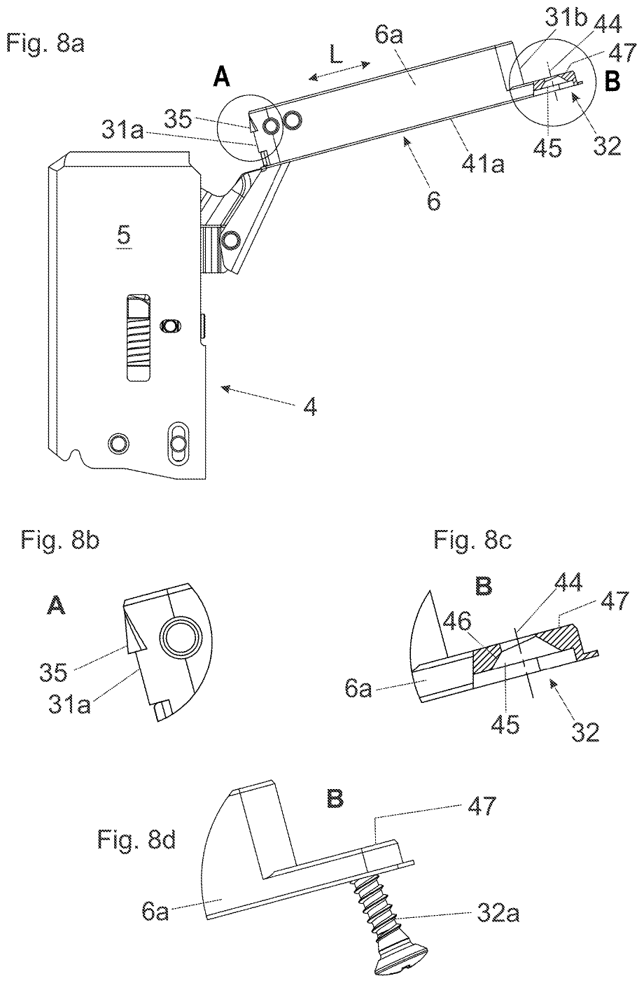

FIG. 8a shows a further embodiment of a fastening device 32 for fastening the fitting portions 5, 6 to the furniture carcass 2 and/or to the movable furniture part 3. The fastening device 32, in the shown figure, will be described in connection with the second fitting portion 6 configured to be fixed to the movable furniture part 3. Of course, the fastening device 32 can also be utilized in connection with the first fitting portion 5.

The fitting portion 6 includes a fastening surface 47 for bearing against the movable furniture part 3, the fastening surface 47 being configured to be flat at least over a region. The fastening device 32 arranged on the second end section 31b of the housing 6 includes a bore 45 having a longitudinal direction extending transversely, for example between 10° and 20°, to a perpendicular 44 extending at a right angle to the fastening surface 47. At least one laterally protruding protrusion 35 is arranged on the first end section 31a of the housing 6a, and the function of the protrusion 35 has already been described in connection with FIG. 6b.

FIG. 8b shows the encircled detail region “A” of FIG. 8a in an enlarged view.

FIG. 8c shows the encircled detail region “B” of FIG. 8a in an enlarged view, in which the inclinedly extending bore 45 with an inclined surface portion 46 is shown.

FIG. 8d shows the actuating element 32a in the form of a rotatable screw, the longitudinal axis of which is tilted in relation to the fastening surface 47 due to the inclinedly extending bore 45. When the actuating element 32a in the form of the screw is rotated, the inclined surface portion 46 of the bore 45 is contacted by the actuating element 32a. In this way, the housing 6a of the second fitting portion 6 is movable in the longitudinal direction (L), and the protrusion 35 of the first end section 31a is pressed against an inner side of the recess 15b, and both end sections 31a, 31b of the housing 6a can be fixed within the recess 15b.

In the shown figure, the bore 45 is configured asymmetrical in relation to the perpendicular 44. The inclined surface portion 46 of the bore 45 is inclined such that the actuating element 32a contacts the inclined surface portion 46 upon a rotational movement of the actuating element 32a, and the housing 6a is movable in a direction extending transversely to the perpendicular 44 by the actuating element 32a.

1. A furniture fitting for movably supporting a movably-mounted furniture part relative to a furniture carcass, the furniture fitting comprising:
a first fitting portion configured to be fixed to the furniture carcass,
a second fitting portion configured to be fixed to the movable furniture part, the two fitting portions being pivotally connected to one another by at least one hinge axis member, and the first fitting portion is configured to be at least partially inserted into a recess in the furniture carcass and/or the second fitting portion is configured to be at least partially inserted into a recess in the movable furniture part,
wherein the first fitting portion and/or the second fitting portion includes or include a longitudinal housing having two end sections spaced from each other in the longitudinal direction, wherein the at least one hinge axis member is arranged on a first end section of the housing,
wherein the first fitting portion and/or the second fitting portion includes or include a fastening device having at least one movably-mounted actuating element in the form of a rotatable screw, wherein by an actuation of the at least one actuating element, the first fitting portion and/or the second fitting portion is or are configured to be fixed within the recess on both end sections of the housing.

2. The furniture fitting according to claim 1, wherein the actuating element of the fastening device is arranged on a region separate from the first end section, on which the hinge axis member is arranged, of the housing.

3. The furniture fitting according to claim 1, wherein the actuating element of the fastening device is arranged on the second end section of the housing.

4. The furniture fitting according to claim 1, wherein the first fitting portion and/or the second fitting portion of the furniture fitting has or have precisely one fastening device for fixing to the furniture carcass and/or for fixing to the movable furniture part.

5. The furniture fitting according to claim 1, wherein at least one locking element is configured to be moved by an actuation of the actuating element, and the housing is configured to be fixed within the recess by the at least one locking element.

6. The furniture fitting according to claim 5, wherein the actuating element is movement-coupled to the locking element, wherein it is preferably provided that the actuating element is in threading engagement with the locking element.

7. The furniture fitting according to claim 5, wherein the at least one locking element includes a first inclined surface portion configured to co-operate with a corresponding second inclined surface portion, the at least one locking element being configured to be moved, upon rotating the actuating element in a first rotational direction, in a first direction extending transversely to the rotational axis of the actuating element by the co-operation of the first and second inclined surface portions.

8. The furniture fitting according to claim 7, wherein the at least one locking element is configured to be moved, upon rotating the actuating element in a second rotational direction opposite the first rotational direction, in a second direction opposite the first direction by the co-operation of the first and second inclined surface portions.

9. The furniture fitting according to claim 5, wherein the at least one locking element includes at least one guide element configured to be displaced along the inclined surface portions.

10. The furniture fitting according to claim 5, wherein the at least one locking element includes, at least over a region, at least one surface for increasing the static friction, preferably at least one rib and/or at least one tooth arrangement, configured to bear against the recess.

11. The furniture fitting according to claim 1, wherein the housing of the first fitting portion and/or of the second fitting portion is or are configured so as to be substantially cuboid-shaped.

12. The furniture fitting according to claim 1, wherein the housing, on the first end section on which the at least one hinge axis member is arranged, includes at least one protrusion configured to bear against the recess.

13. The furniture fitting according to claim 1, wherein the first fitting portion and/or the second fitting portion of the furniture fitting is or are configured to be fixed to or within a furniture panel.

14. The furniture fitting according to claim 13, wherein the first fitting portion and/or the second fitting portion, in a mounted condition on the furniture panel, is or are received, for the most part, within a recess of the furniture panel.

15. The furniture fitting according to claim 1, wherein the first fitting portion includes a mounting portion having at least one fixing device for mounting the mounting portion to the furniture carcass, and that the first fitting portion includes at least one coupling portion hingedly connected to the second fitting portion, the at least one coupling portion being configured to be releasably connected to the mounting portion.

16. The furniture fitting according to claim 1, wherein the first fitting portion and/or the second fitting portion includes or include a fastening surface configured to bear against the furniture carcass and/or to the movable furniture part, the fastening device including at least one bore having a longitudinal direction for the passage of the actuating element, the longitudinal direction of the bore extending inclinedly to a perpendicular extending at a right angle to the fastening surface.

17. The furniture fitting according to claim 16, wherein the bore is configured asymmetrical in relation to the perpendicular.

18. The furniture fitting according to claim 16, wherein the bore includes an inclined surface portion configured to be inclined such that the actuating element, upon a rotational movement, contacts the inclined surface portion, and the housing is movable in a direction transversely to the perpendicular by the actuating element.

19. The furniture fitting according to claim 1, wherein the first fitting portion and/or the second fitting portion includes or include at least one laterally protruding flange configured to bear against the furniture carcass and/or against the movable furniture part, wherein it is preferably provided that the flange is configured to bear against a front face of the furniture carcass and/or against a front face of the movable furniture part.

20. The furniture fitting according to claim 1, wherein the furniture fitting is configured as a furniture hinge.

21. An item of furniture comprising a furniture carcass, a furniture part movably supported relative to the furniture carcass, and the furniture fitting according to claim 1 for moving the furniture part relative to the furniture carcass.
